(19) United States
(12) Patent Application Publication
(10) Pub. No.: US 2016/0242392 A1
(43) Pub. Date: Aug. 25, 2016

(54) PET TRANSPORTER

(71) Applicant: Poppy Holzworth, Cornelius, NC (US)

(72) Inventor: Poppy Holzworth, Cornelius, NC (US)

(21) Appl. No.: 14/994,410

(22) Filed: Jan. 13, 2016

Related U.S. Application Data
(60) Provisional application No. 62/102,964, filed on Jan. 13, 2015.

(51) Int. Cl. A01K 15/02; A01K 29/00; A61H 3/04; A01K 27/00

(52) U.S. Cl. CPC A01K 15/027; A01K 27/002; A01K 29/00; A61H 3/04; A61H 2203/03

(57) ABSTRACT

Pet transporters include an elongated primary member having a proximal end and a distal end, a handle disposed at the proximal end, at least one wheel rotatably attached to the distal end, and a support harness suspended from the primary member intermediate the proximal end and the distal end, the support harness configured to orient an animal beneath the primary member and in a longitudinal direction substantially parallel to the primary member, such that the animal's feet contact ground during use. Additional pet transporters include a primary member including an arcuate portion extending upward and forward from a carriage to an uppermost location, a generally vertical portion extending downward from the uppermost location, and a generally horizontal portion extending from the vertical portion to a handle.

### CROSS-REFERENCE TO RELATED APPLICATION

This application claims the benefit of U.S. Provisional Patent Application Ser. No. 62/102,964, filed Jan. 13, 2015, the disclosure of which is hereby incorporated herein in its entirety by this reference.

### TECHNICAL FIELD

Embodiments of the present disclosure relate generally to devices for assisting and transporting pets. Additional embodiments include methods of making and using such devices.

### BACKGROUND

Some domestic pets, such as dogs, have difficulty walking. For example a pet may have difficulty walking due to surgery, injury, fatigue, disease, arthritis, or old age. Such animals are often unable walk or exercise unless they are assisted. Existing devices designed to assist disabled animals to walk may provide little, if any, ability for the owner to guide and control the animal, or may not encourage or allow the pet to engage in significant exercise. Other devices that allow the pet owner to exert more guidance and control over the animal may have poor ergonomic design with respect to the pet owner. Such limitations may discourage use by both the pet owner and the animal. Lack of exercise may prevent effective healing or may exacerbate the health problems of the animal.

### BRIEF SUMMARY

In some embodiments, pet transporters include an elongated primary member having a proximal end and a distal end and a handle configured to be gripped by an animal handler. The handle is disposed at the proximal end of the primary member. At least one wheel is rotatably attached to the distal end of the primary member. A support harness is suspended from the primary member intermediate the proximal end and the distal end, the support harness configured to orient an animal beneath the primary member and in a longitudinal direction substantially parallel to the primary member, such that the animal's feet contact ground during use.

In some embodiments, pet transporters include a primary member extending between a carriage configured to move along a ground surface and a handle configured to be gripped by an animal handler. The primary member includes an arcuate portion extending upward and forward from the carriage to an uppermost location on the primary member, a generally vertical portion extending downward from the uppermost location on the primary member to a lower end of the generally vertical portion, and a generally horizontal portion extending forward from the lower end of the generally vertical portion to the handle. An animal support device is suspended from the arcuate portion of the primary member.

In some embodiments, pet transporters include a primary member extending between a carriage and a handle and a support harness suspended from the primary member at a location intermediate the carriage and the handle. The primary member and the support harness are configured such that an upward force applied to the handle results in an upward force at the support harness greater than one times the upward force applied to the handle as the primary member pivots at the carriage.

In some embodiments, methods of manufacturing a pet transporter include rotatably attaching at least one wheel at a distal end of a primary member comprising a handle at an opposite, proximal end, the handle being configured to be gripped by an animal handler, and coupling a support device to a portion of the primary member intermediate the proximal end and the distal end, the support device configured to orient an animal to a longitudinal direction substantially parallel to and underneath the primary member, such that the animal's feet contact ground during use.

### BRIEF DESCRIPTION OF THE DRAWINGS

FIG. 1 is a side view of a pet transporter according to an embodiment of the disclosure;

FIG. 2 is a rear view of a carriage member of a pet transporter according to an embodiment of the disclosure;

FIG. 3 is a rear view of a carriage member of a pet transporter according to an embodiment of the disclosure;

FIG. 4 is a rear view of a carriage member of a pet transporter according to an embodiment of the disclosure; and

FIG. 5 is a side view of a pet transporter according to an embodiment of the disclosure.

### DETAILED DESCRIPTION

The illustrations presented herein are not meant to be actual views of any particular material, apparatus, system, or method, but are merely idealized representations, which are employed to describe example embodiments of the present invention.

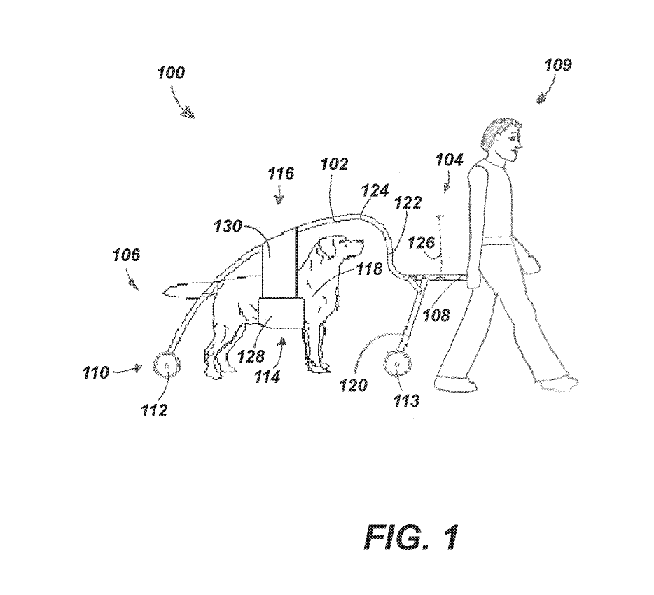

FIG. 1 illustrates a pet transporter 100 of the present disclosure. The pet transporter 100 may include a primary member 102 having a proximal end 104, which is proximate an animal handler 109 during use, and a distal end 106, which is distant from the animal handler 109 during use. The proximal end 104 may include a handle 108 configured to be comfortably held in the hand of the animal handler 109. The distal end 106 of the primary member 102 may be attached to a carriage portion 110 including at least one component that enables movement over ground, such as one or more rear wheels 112. A support device 114 may be affixed to the primary member 102 and may be configured to support (i.e., bear at least a portion of the weight of) an animal such as a dog 118 such that the animal is oriented beneath and longitudinally parallel with a length of the primary member 102. In some embodiments, a support strut 120 including one or more front wheels 113 may be attached to the primary member 102 at the proximal end 104 of the primary member 102, such as proximate the handle 108. The one or more front wheels 113 may be rotatable about a generally vertical axis to facilitate turning of the pet transporter 100.

At least a portion of the primary member 102 may extend in a generally arcuate fashion from the distal end 106 to the proximal end 104. For example, the primary member 102 may include one or more arcuate portions located between the distal end 106 and the proximal end 104. In the embodiment shown in FIG. 1, the primary member 102 may include an arcuate portion 116 extending upward and longitudinally (i.e., along a length of the primary member 102 from the distal end 106 to the proximal end 104) forward from the carriage member 110. The arcuate portion 116 may extend upward a distance sufficient to provide clearance for an animal, such as a dog 118, to move its body and head about while standing or walking, and may extend longitudinally a distance sufficient to accommodate leg and body movement associated with the animal's natural stride. The arcuate portion 116 may include a substantially constant radius of curvature, or the radius of curvature of the arcuate portion 116 may vary along the length of the arcuate portion 116 between the distal end 106 and the proximal end 104. For example, the radius of curvature of the arcuate portion 116 may have a first value proximate the distal end 106 and may increase gradually or stepwise to a second, greater value near the proximal end 104.

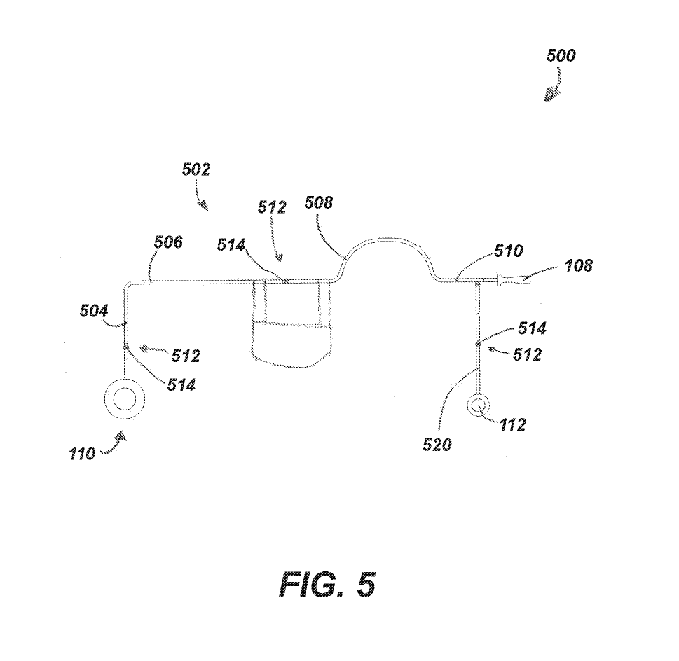

In some embodiments, the arcuate portion 116 may terminate at a handle connection portion 122 of the primary member 102. The handle connection portion 122 may extend downward from a topmost point 124 of the arcuate portion 116 a distance 126 that places the handle 108 at a height comfortable for use by the animal handler 109. As shown in FIG. 1, the handle connection portion 122 may be generally vertical. In other embodiments, the handle connection portion 122 may extend at an upward or downward angle, or extend generally horizontally between the topmost point 124 of the arcuate portion 116 and the handle 108. The primary member 102 may be provided in different sizes or, as discussed in further detail below in connection with FIG. 5, portions of the primary member 102 may be adjustable to accommodate animals of different size and animal handlers of different heights.

The primary member 102 may be a single, unitary member or a member including more than one component coupled together. The primary member 102 may be made from, for example, a metal alloy, a polymer, or a composite material (e.g., fiberglass, carbon fiber composite). The primary member 102 may be formed with a cross-sectional shape such as, for example, a circle, a square, a rectangle, an oval, an I-beam, or other shapes. The shape and size of the cross-section of the primary member 102 may be chosen to provide a desired level of elastic deformation. For example, the primary member 102 may have a size, shape, and material that provides a high level of rigidity. Alternatively, the primary member 102 may be designed to have vibration-dampening characteristics, or to allow relatively large elastic deformations for a shock-absorbing effect. Additionally, the primary member 102 may include features such as a water bottle holder or a storage area for animal care items or the animal handler's personal items.

The support device 114 may be configured to provide support to (i.e., bear at least a portion of the weight of) an animal, such as the dog 118, while allowing the animal's legs to extend normally and contact a ground surface. For example, the support device 114 may include a sling or harness 128 made from a flexible material, such as rubber or neoprene, or a woven textile, such as cotton, nylon, or polyester. The support device 114 may be configured to support the animal by surrounding and supporting the animal's torso and/or abdomen. In some embodiments, the harness 128 may include openings through which the animal's front and/or rear legs may pass. The harness 128 of the animal support device 114 may be configured to distribute the animal's weight evenly over a relatively large area, thus providing for the animal's comfort.

The harness 128 may be suspended from the primary member 102 by one or more members such as a flexible strap 130. The harness 128 may be configured to orient the animal generally longitudinally parallel to the length of the primary member 102 and beneath the primary member 102. The harness 128 may be detachably connected to the primary member 102 so that the animal can be quickly and easily removed from the pet transporter 100 with or without removing the animal from the harness 128. For example, the straps 130 may be connected to the primary member 102 by one or more hook and loop fasteners, plastic or metal buckles, or similar devices. Similarly, the harness 128 may include snaps, buttons, zippers, hook and loop fasteners, or other devices to enable the harness to be positioned and secured around the animal.

In some embodiments, the material of the harness 128 may be made to include ventilation openings, or may be woven as a mesh or loose weave to provide comfort to the animal in hot weather. In some embodiments, the material of the harness 128 may treated with a fire retardant, or may be made from a fire-resistant material. In other embodiments, such as those intended to be used near bodies of water, the harness 128 may include a flotation device or aid. In yet other embodiments, the harness 128 may be made from or include insulating material for cold weather use.

For animals incapable of walking, or when the animal handler 109 desires the animal to rest, the harness 128 may be replaced by a rigid platform or housing suspended from the primary member 102. The animal may then be placed onto or into the platform or housing and transported by the animal handler 109.

In some embodiments, the pet transporter 100 may include a support strut 120 depending from the proximal end 104 of the primary member 102. The support strut 120 may include one or more rotatable front wheels 113 attached thereto. Additionally, the one or more front wheels 113 may be rotatable about a generally vertical axis to facilitate turning the pet transporter without requiring the animal handler to lift the support strut 120 and associated front wheels 113 off the ground. In some embodiments, the front wheels 113 on the support strut 120 and/or the back wheels 112 may include a brake or lock to allow the animal handler to slow down or stop the pet transporter 100. The height of the support strut 120 may be adjustable. For example, the support strut 120 may be affixed to the primary member 102 with a pivot, as shown in FIG. 1, so that the support strut 120 may be pivoted to position the primary member 102 at a different height. In addition, a pivoting support strut 120 may be configured for pivoting away from the ground to use the pet transporter 100 without the support strut 120. Alternatively, the support strut 120 may be removably affixed to the primary member 102, or may include a telescoping joint for height adjustment, as discussed in greater detail in connection with FIG. 5 below.

The primary member 102 may form a lever device, with a fulcrum located at the axis of rotation of the rear wheels 112, the load applied by the harness 128 suspended from an intermediate location on the primary member 102, and the force applied by the animal handler 109 at the handle 108. A mechanical advantage may be provided to the animal handler, i.e., the animal handler 109 may lift at least a portion of the weight of the animal by applying a lifting force at the handle 108 that is less than the weight of the animal. Alternatively, in embodiments including a support strut 120 the animal handler 109 may lift at least a portion of the weight of the animal by pressing down on the handle and using the axis of rotation of the front wheels 113 as a fulcrum. The mechanical advantage provided to the animal handler may be greater than 1:1, such as, for example, 2:1, 3:1, or more. The mechanical advantage may be varied by changing the location between the fulcrum (e.g., the carriage portion 110, the support strut 120) and the handle 108 at which the harness 128 is suspended. The mechanical advantage increases as the harness 128 is positioned closer to the fulcrum. A higher mechanical advantage may allow a child or small adult to lead a relatively large or heavy animal with ease.

The animal handler 109 may vary the portion of the animal's weight supported by the harness 128 by varying a force applied to the handle 108. For example, if the animal is capable of walking normally but tires easily, the animal handler 109 may initially provide little force on the handle 108, allowing the harness strap 130 to slacken and the animal to walk normally. As the animal tires and requires more assistance, the animal handler 109 may increase force on the handle 108, thus allowing the harness 128 to support at least a portion of the animal's weight. In some cases, such as where the animal is incapable of walking normally, or is capable of walking but because of excitement or distraction becomes uncontrollable, the animal handler 109 may apply a force sufficient to lift the animal's legs completely off the ground, thereby supporting the full weight of the animal by the harness 128. In embodiments of the pet transporter 100 including a support strut 120, the support strut may be adjustable to allow the animal handler to choose the portion of the animal's weight supported by the harness 128. Thus, the support strut 120 may be adjusted to bear the portion of the animal's weight supported by the harness 128, and the animal handler may simply lead the animal by directing the pet transporter 100 by the handle 108 without applying a force sufficient to lift at least a portion of the animal's weight.

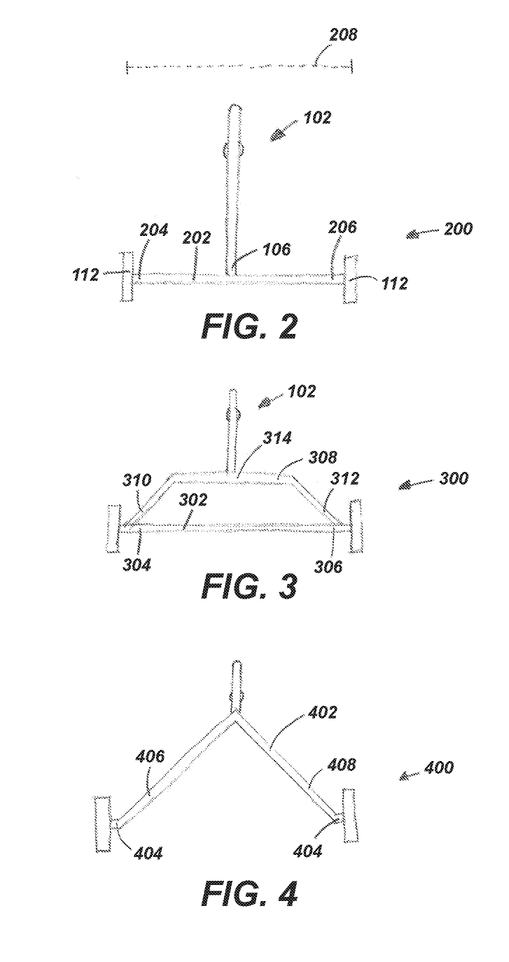

The carriage portion 110 of the pet transporter 100 (FIG. 1) may be configured to provide lateral stability to the pet transporter 100 and to facilitate movement along a ground surface. For example, referring now to FIG. 2, a carriage portion 200 may include an axle member 202 connected to a distal end 106 of a primary member 102. The primary member 102 may be configured to attach to the axle member 202 at a center of the axle member 202. The axle member 202 may extend laterally outward on either side of the primary member 102, and may include at least one rear wheel 112 at each of first and second lateral ends 204 and 206. Each of the rear wheels 112 may be rotatably connected to the axle member 202 with bearings such as plain, roller, or ball bearings. In some embodiments, each rear wheel 112 may include, for example, a solid or pneumatic rubber tire. The size, shape, and tread pattern of the tires may be chosen based on the terrain over which the pet transporter 100 is used. For example, relatively small, solid rubber tires may be appropriate for use on paved surfaces such as sidewalks, roads, and paved recreation trails. Relatively larger pneumatic tires may be more appropriate for rough or irregular surfaces such as dirt or gravel trails. In some embodiments, the carriage portion 200 may include skis or skates in place of wheels to facilitate cold-weather use atop snow and/or ice.

The axle member 202 may have a width 208 that may be fixed or adjustable. For example, the axle member 202 may include one or more telescoping joints, as described below in connection with FIG. 5. In some embodiments, each rear wheel 112 may be provided with a brake to slow down or stop movement of the pet transporter 100 (FIG. 1). In some embodiments, the brake may be operated by a control device located at the handle 108 (FIG. 1).

In some embodiments, the carriage portion may include a member with a laterally central portion coupled to the primary member 102 and lateral ends configured to couple to an axle member. For example, in the embodiment shown in FIG. 3, a carriage portion 300 may include a generally U-shaped member 308. The U-shaped member 308 may include a laterally central portion 314 coupled to the primary member 102. The U-shaped member 308 may also include lateral ends 310 and 312 coupled to lateral ends 304 and 306 of an axle member 302.

Alternatively, as shown in FIG. 4, a carriage portion 400 may include a generally V-shaped member 402 configured to support stub axles 404 extending in cantilever fashion from lateral ends 406 and 408 of the generally V-shaped member 400.

Thus, the carriage portion 110, 200, 300, 400 may include a member of any shape that provides a laterally central portion to affix the primary member 102 and lateral ends to support the axle member 202, 302 or, alternatively, to support stub axles 404.

Furthermore, in some embodiments, the carriage portion 110, 200, 300, 400 may include a suspension system, such as a spring and damper suspension, to reduce the vibration and shock felt by the animal and the animal handler 109 (FIG. 1) as the pet transporter 100 (FIG. 1) travels along rough or irregular ground. In other embodiments, a suspension system may include elastomeric components that function as a spring and/or damper.

In some embodiments, the primary member 102 may include both rectilinear segments and arcuate segments as it extends forward and generally upward from the distal end 106 to the proximal end 104 (FIG. 1). For example, in the embodiment of FIG. 5, a pet transporter 500 may include a primary member 502 that includes a generally vertical segment 504 extending upward from the carriage portion 110, a generally horizontal segment 506 extending longitudinally from the generally vertical segment 504 to a head portion 508, and an additional horizontal segment 510 extending forward from the head portion 508 to a handle 108. The head portion 508 may be configured to provide space for an animal, such as a dog 118 (FIG. 1), to move its head about while standing or walking. For example, the head portion 508 may be configured substantially as a semicircle or a semi-ellipse, as shown in FIG. 5. Alternatively, the head portion 508 may be configured as a portion of a square, rectangle, or any other shape that provides space for an animal. The respective dimensions of the vertical segment 504 and the horizontal segments 506 and 510 may be chosen to provide an animal with sufficient room to walk or run, and to place the handle 108 at a height comfortable for the animal handler 109 (FIG. 1).

In some embodiments, the primary member 502 and support strut 520 may be made adjustable to accommodate animals of different size and animal handlers 109 (FIG. 1) of different heights. For example, the primary member 502 may include multiple components connected at one or more telescoping joints 512, with corresponding locking collars 514 disposed at each of the one or more telescoping joints 512. The locking collars 514 may be loosened by, for example, loosening a set screw or threaded ring, to enable the telescoping joint to be adjusted to the desired position. The locking collars 514 may then be retightened to fix the position of the telescoping joints 512. In other embodiments, the telescoping joints 512 may be fixed at various positions using other mechanisms, such as using one or more spring buttons and corresponding holes through the primary member 502. Thus, the height and/or length of the pet transporter 100 may be adjusted based on a range of animal sizes, animal types, and animal handler heights. Additionally, the components of the pet transporter 500 may be disassembled at the telescoping joints 512 or at other locations to enable the pet transporter 500 to be easily stored or moved when not in use.

While the examples herein have referred to an animal such as a dog, it should be understood by a person of ordinary skill in the art that such a device may be useful for transporting, rehabilitating, or assisting many different types of animals by altering or adjusting the dimensions of the device. For example, the pet transporter may be configured to transport animals such as, for example only and without limitation, dogs, cats, rodents, small livestock, zoo animals, or any other animal capable of walking.

While certain illustrative embodiments have been described in connection with the figures, those of ordinary skill in the art will recognize and appreciate that the scope of this disclosure is not limited to those embodiments explicitly shown and described herein. Rather, many additions, deletions, and modifications to the embodiments described herein may be made to produce embodiments within the scope of this disclosure, such as those hereinafter claimed, including legal equivalents. In addition, features from one disclosed embodiment may be combined with features of another disclosed embodiment while still being within the scope of this disclosure, as contemplated by the inventor.

What is claimed is:

1. A pet transporter, comprising:
an elongated primary member having a proximal end and a distal end;
a handle configured to be gripped by an animal handler, the handle disposed at the proximal end of the primary member;
at least one wheel rotatably attached to the distal end of the primary member; and
a support harness suspended from the primary member intermediate the proximal end and the distal end, the support harness configured to orient an animal beneath the primary member and in a longitudinal direction substantially parallel to the primary member, such that the animal's feet contact ground during use.

2. The pet transporter of claim 1, wherein the primary member is adjustable in length.

3. The pet transporter of claim 1, wherein the primary member comprises at least two segments coupled to each other.

4. The pet transporter of claim 1, wherein the at least one wheel comprises at least two wheels separated by an axle member.

5. The pet transporter of claim 1, further comprising a support strut coupled to the primary member proximate the handle.

6. The pet transporter of claim 5, wherein the support strut comprises a wheel rotatably attached at a bottom of the support strut.

7. A pet transporter, comprising:
a primary member extending between a carriage configured to move along a ground surface and a handle configured to be gripped by an animal handler, the primary member comprising:
an arcuate portion extending upward and forward from the carriage to an uppermost location on the primary member;
a generally vertical portion extending downward from the uppermost location on the primary member to a lower end of the generally vertical portion; and
a generally horizontal portion extending forward from the lower end of the generally vertical portion to the handle; and
an animal support device suspended from the arcuate portion of the primary member.

8. A pet transporter, comprising:
a primary member extending between a carriage and a handle; and
a support harness suspended from the primary member at a location intermediate the carriage and the handle;
wherein the primary member and the support harness are configured such that an upward force applied to the handle results in an upward force at the support harness greater than one times the upward force applied to the handle as the primary member pivots at the carriage.
